(19) United States
(12) Patent Application Publication
(10) Pub. No.: US 2016/0258341 A1
(43) Pub. Date: Sep. 8, 2016

(54) ENGINE COOLING SYSTEM HAVING THERMOSTAT

(71) Applicants: Hyundai Motor Company, Seoul (KR); Kia Motors Corporation, Seoul (KR)

(72) Inventors: Seok Jun Yoon, Anyang-si (KR); Joong Hyun Hwang, Suwon-si (KR)

(73) Assignees: Hyundai Motor Company, Seoul (KR); Kia Motors Corporation, Seoul (KR)

(21) Appl. No.: 14/822,669

(22) Filed: Aug. 10, 2015

(30) Foreign Application Priority Data
Mar. 2, 2015 (KR) 10-2015-0029320

(51) Int. Cl. F01P 7/16; F01P 3/14; F02M 26/73; F01P 3/20; F02M 26/28; F01P 3/02; F01P 11/08

(52) U.S. Cl. CPC F01P 7/16; F01P 3/02; F01P 3/14; F01P 11/08; F01P 3/20; F02M 26/28; F02M 26/73; F01P 2003/027; F01P 2007/146

(57) ABSTRACT

An engine cooling system having thermostat may include a cylinder head disposed on a cylinder block and forming a combustion chamber with the cylinder block, and configured to include an intake port and an exhaust port connected to the combustion chamber, a coolant valve configured to receive a coolant that is passed through the cylinder head and the cylinder block and exhausted from each of a first side of the cylinder head and the cylinder block, and configured to distribute the coolant to cooling elements, an oil cooler disposed to control temperature of an oil that circulates through the cylinder head or the cylinder block, and a thermostat configured to receive a coolant exhausted from a second side of the cylinder block, and selectively transmit the coolant to the oil cooler.

### CROSS-REFERENCE TO RELATED APPLICATION

The present application claims priority to Korean Patent Application No. 10-2015-0029320 filed Mar. 2, 2015, the entire contents of which is incorporated herein for all purposes by this reference.

### BACKGROUND OF THE INVENTION

1. Field of the Invention

The present invention relates to an engine cooling system having a thermostat and shortening warm-up time of an engine by respectively controlling coolants flowing in a cylinder head and a cylinder block and controlling a coolant exhausted from the cylinder block using a thermostat.

2. Description of Related Art

A vehicle has a cooling system, and this cooling system prevents overheating of an engine and radiates heat of the engine to the outside.

In this case, a coolant is circulated in an engine block and a cylinder head so as to eliminate heat of the hot engine, the heated coolant flows through a radiator disposed at the front side of the vehicle, and the radiator radiates heat of the coolant to the outside.

The heated coolant is circulated in a heat exchanger (a heater core) for heating the inside of the vehicle, and the cooling system uses various valves and thermostats.

Further, an EGR line recirculates an exhaust gas from an exhaust line to an intake line of the engine, an EGR cooler and an EGR valve are disposed to the EGR line, and the coolant is circulated to the EGR cooler, the EGR valve, and an oil cooler.

Recently, a coolant valve separately controls coolants flowing in the cylinder head and the cylinder block, the coolant valve separately controls coolants distributed to the cylinder head and the radiator, and the coolant valve controls the coolant supplied from the cylinder block.

Further, some of coolant flowing in the cylinder block is distributed to the EGR valve, the EGR cooler, and the oil cooler, the coolant is circulated to the EGR cooler, the EGR valve, and the oil cooler through the cylinder block in a state in which the temperature of coolant is relatively low, and as a result, warm-up time of the engine may be increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine cooling system having a thermostat which can improve combustion efficiency and shorten warm-up time of an engine, by controlling some of coolant circulated from a cylinder block to an EGR cooler, an EGR valve, and an oil cooler, and decreasing a flow of coolant flowing through the cylinder block in a state in which a temperature of coolant is low.

According to various aspects of the present invention, an engine cooling system having thermostat may include a cylinder head disposed on a cylinder block and forming a combustion chamber with the cylinder block, and configured to include an intake port and an exhaust port connected to the combustion chamber, a coolant valve configured to receive a coolant that is passed through the cylinder head and the cylinder block and exhausted from each of a first side of the cylinder head and the cylinder block, and configured to distribute the coolant to cooling elements, an oil cooler disposed to control temperature of an oil that circulates through the cylinder head or the cylinder block, and a thermostat configured to receive a coolant exhausted from a second side of the cylinder block, and selectively transmit the coolant to the oil cooler.

The cooling elements may include a radiator configured to disperse heat of the coolant to an outside, an Exhaust Gas Recirculation (EGR) cooler disposed on an EGR line which is configured to recirculate an exhaust gas exhausted from the exhaust port to the intake port, and disposed to cool a recirculation exhaust gas, and a heater disposed to heat internal air of a vehicle.

The engine cooling system may further include an EGR line configured to recirculate an exhaust gas, which is discharged from the exhaust port to the intake port, to the intake port, and an EGR valve disposed in the EGR line, in which the coolant having passed through a first side of the thermostat may be passed through one side of the EGR valve and cools it.

The thermostat may be configured to continuously circulate the coolant supplied from the cylinder block to the EGR valve.

The thermostat may include a thermostat housing having an inlet that is supplied with a coolant from the cylinder block at the first side, having an outlet that supplies the coolant to the oil cooler at a second side, having a housing space between the inlet and the outlet, and having a branching path that is branched from the housing space and connected to the EGR valve, a piston shaft having a first end portion fixed to a fixing unit that is fixed at a central portion of the outlet, a piston case in which a second end portion of the piston shaft is inserted, a wax case engaged to the piston case, and filled with a wax according to a temperature therein, and a first valve fixed to an outer part of the piston case and disposed to open and close the outlet according to a contraction and expansion state of the wax.

The thermostat may further include a guide plate of which an end portion of the wax case is disposed to be inserted at a central portion, and an edge is disposed at a guide groove that is formed at an interior circumference of the inlet, and an elastic member elastically supporting the wax case toward the fixing unit with respect to the guide plate so as to close the outlet by the first valve.

The EGR cooler and the heater may be sequentially disposed at a coolant line to supply the coolant having passed through the EGR cooler to the heater.

The coolant valve may be configured to separately control a coolant supplied to the EGR cooler and the radiator, and continuously receive the coolant from the cylinder head and selectively receive the coolant from the cylinder block.

An edge of the guide plate may be inserted to the guide groove, so as to move from the inlet to the outlet along a length direction of the guide groove.

According to the present invention for achieving the object, a coolant exhausted from the cylinder block is controlled by a thermostat and is selectively supplied to an oil cooler in the structure separately cooling a cylinder head and a cylinder block by a coolant valve, and as a result, overall combustion efficiency may be improved by minimizing coolant flows of the cylinder block and decreasing warm-up time of the engine, and an LOT (light-off time) of a catalyst unit disposed in an exhaust line may be reduced.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary engine cooling system having a thermostat related to the present invention.

FIG. 2 is overall schematic diagram of an exemplary engine cooling system having a thermostat according to the present invention.

FIG. 3 is overall cross-sectional view showing operation states of a thermostat in a low temperature coolant state according to the present invention.

FIG. 4 is overall cross-sectional view showing operation states of a thermostat in a high temperature coolant state according to the present invention.

FIG. 5 is a graph showing effectiveness of using a thermostat according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

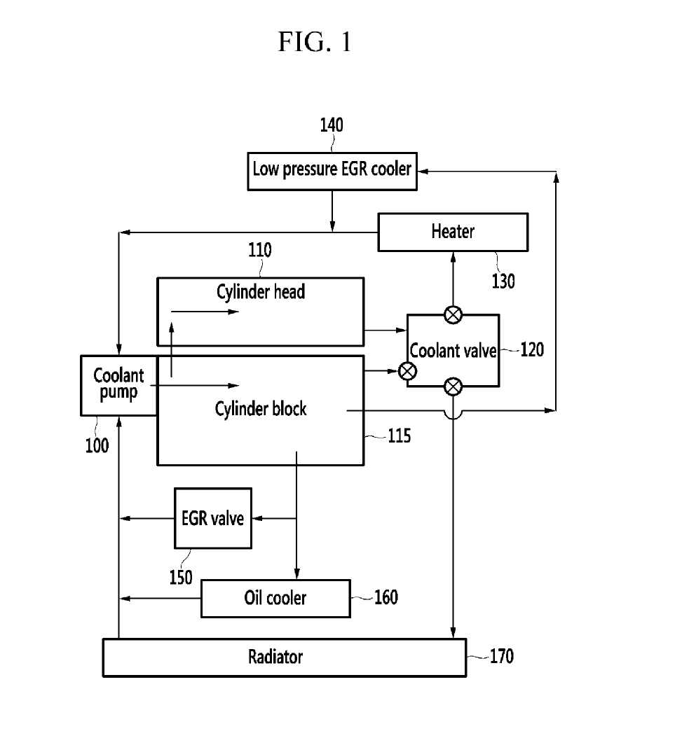

FIG. 1 is a schematic diagram of an engine cooling system having a thermostat related to the present invention.

Referring to FIG. 1, an engine cooling system includes a cylinder head 110, a cylinder block 115, a coolant pump 100, a coolant valve 120, a heater 130, a low pressure EGR cooler 140, an EGR valve 150, an oil cooler 160, and a radiator 170.

The coolant pump 100 is disposed at one side of the cylinder block 115 and pumps a coolant to a coolant inlet side of the cylinder block 115, and the coolant valve 120 is disposed at the other side of the cylinder block 115 and receives a coolant from the cylinder head 110 and selectively receives a coolant from the cylinder block 115.

A coolant supplied to the coolant valve 120 is selectively distributed to the heater 130 and the radiator 170, and some of coolant supplied to the cylinder block 115 is supplied to the EGR valve 150 and the oil cooler 160, and some is supplied to the low pressure EGR cooler 140.

A coolant exhausted from the heater 130, the low pressure EGR cooler 140, the oil cooler 160, the EGR valve 150, and the radiator 170 is recirculated to an intake side of the coolant pump 100.

The low pressure EGR cooler 140 is installed in an EGR line and disposed to cool a recirculation exhaust gas recirculated from an exhaust line to an intake line, and the EGR line is branched from a downstream side of a catalyst unit and joins the intake line.

The heater 130 is disposed to heat internal air of a vehicle, the EGR valve 150 is disposed to control a flow of a recirculation exhaust gas flowing through the EGR line, and the oil cooler 160 is disposed to cool oil circulated through the cylinder head 110 and the cylinder block 115.

Further, the radiator 170 is disposed to perform a function of radiating heat of a coolant to the outside.

As shown, a coolant supplied to the cylinder block 115 is distributed to the low pressure EGR cooler 140, the coolant valve 120, the EGR valve 150, and the oil cooler 160, and even if a line supplying to the coolant valve 120 is closed, a coolant is continuously supplied to the EGR valve 150, the oil cooler 160, and the low pressure EGR cooler 140, and warm-up time of coolant may be increased.

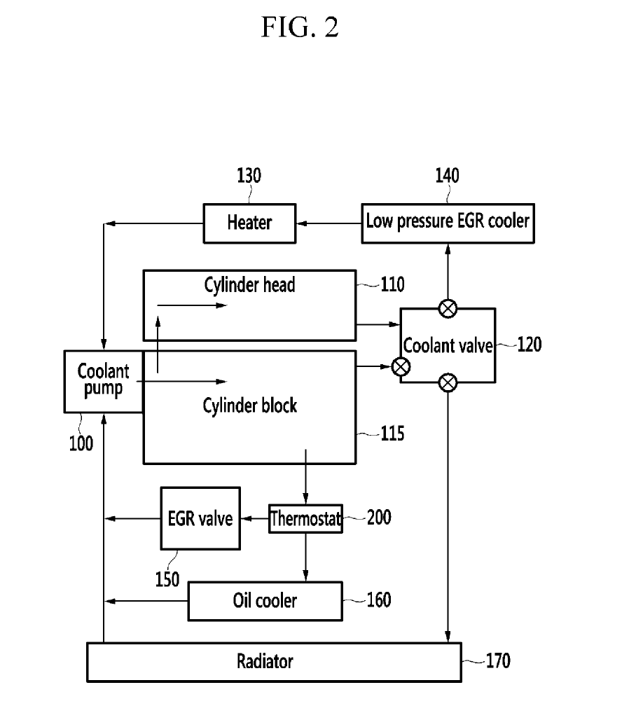

FIG. 2 is an overall schematic diagram of an engine cooling system having a thermostat according to various embodiments of the present invention.

Referring to FIG. 2, the engine cooling system includes a cylinder head 110, a cylinder block 115, a coolant pump 100, a coolant valve 120, a heater 130, a low pressure EGR cooler 140, an EGR valve 150, an oil cooler 160, a thermostat 200, and a radiator 170.

The coolant pump 100 is disposed at one side of the cylinder block 115 and pumps a coolant to a side of the cylinder block 115, and the coolant valve 120 is disposed at the other side of the cylinder block 115 and receives the coolant from the cylinder head 110 and selectively receives the coolant from the cylinder block 115.

A coolant supplied to the coolant valve 120 is selectively distributed to the low pressure EGR cooler 140 and the radiator 170, and some of coolant supplied to the cylinder block 115 is supplied to the thermostat 200.

A coolant supplied to the thermostat 200 is distributed to the EGR valve 150 and the oil cooler 160.

Further, a coolant supplied to the low pressure EGR cooler 140 is circulated to the heater 130.

A coolant exhausted from the heater 130, the oil cooler 160, the EGR valve 150, and the radiator 170 is recirculated to an intake side of the coolant pump 100.

In various embodiments of the present invention, a coolant supplied to the cylinder block 115 is distributed to the coolant valve 120 and the thermostat 200, and a coolant supplied to the thermostat 200 is distributed to the EGR valve 150 and the oil cooler 160.

The thermostat 200 supplies a coolant to the EGR valve 150 at all times, and selectively supplies a coolant to the oil cooler 160 according to a temperature of the coolant.

Therefore, if the temperature of the coolant is lower than a predetermined value, a line supplying the coolant to the coolant valve 120 is closed, and the coolant is continuously supplied to the EGR valve 150, and by closing a supply of coolant to the oil cooler 160, it is possible to reduce warm-up time of the coolant in a low temperature state thereof.

In various embodiments of the present invention, a cylinder is formed in the cylinder block 115, the cylinder head 110 is installed on the cylinder block 115, the cylinder head 110 forms a combustion chamber with the cylinder block 115, and an intake port and an exhaust port connected to the combustion chamber are formed in the cylinder head 110.

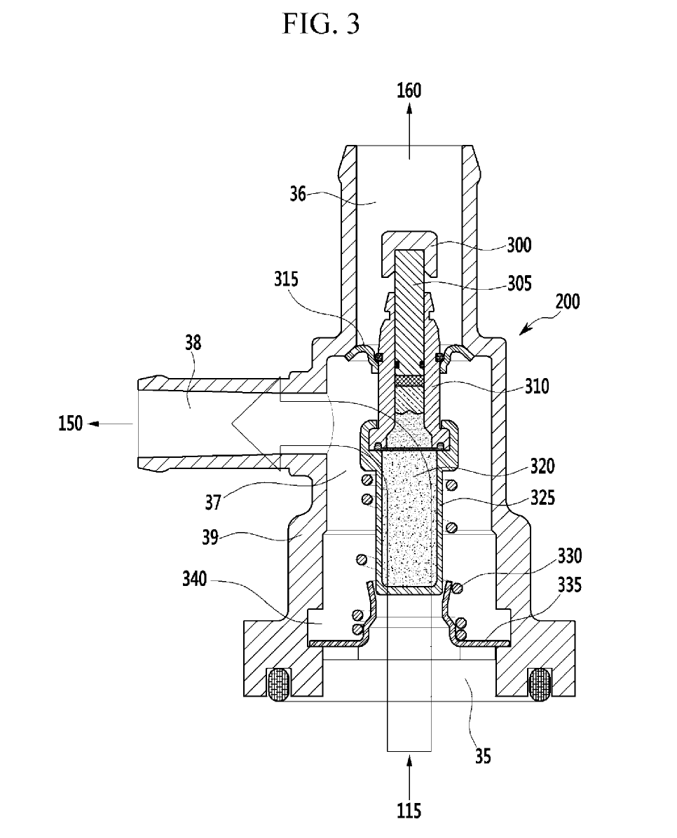

FIG. 3 is an overall cross-sectional view showing operation states of a thermostat in a low temperature coolant state according to various embodiments of the present invention.

Referring to FIG. 3, a thermostat 200 includes a thermostat housing 39, a fixing unit 300, a piston shaft 305, a piston case 310, wax 320, a wax case 325, an elastic member 330, a guide plate 335, an inlet 35, a guide groove 340, a housing space 37, a branching path 38, and an outlet 36.

The inlet 35 is formed in a lower central portion of the thermostat housing 39, the outlet 36 is formed in an upper central portion corresponding to the inlet 35, and the housing space 37 is formed between the inlet 35 and the outlet 36.

Further, the branching path 38 branched from the housing space 37 and extended to the left side is formed between the inlet 35 and the outlet 36.

The inlet 35 is connected to the cylinder block 115 to receive the coolant, the coolant having flowed to the inlet 35 moves to the housing space 37, and it is respectively exhausted to the outlet 36 and the branching path 38 in the housing space 37.

The outlet 36 is connected with the oil cooler 160, and the branching path 38 is connected with the EGR valve 150.

In this case, the branching path 38 is always open, and a coolant flowing into the inlet 35 is always circulated to the EGR valve 150.

The fixing unit 300 is integrally formed in a central portion of the outlet 36, and an upper portion of the piston shaft 305 is fixed in the fixing unit 300 and extended to a lower side.

A lower portion of the piston shaft 305 is inserted to an upper side of the piston case 310, and the wax case 325 is engaged to a lower side of the piston case 310.

In this case, the wax 320 is filled at the inside of the wax case 325, and the wax 320 pushes or pulls the piston shaft 305 according to the contraction and expansion state of the wax 320.

A first valve 315 is fixed and disposed at one side of an exterior circumference of the piston case 310, and the first valve 315 is disposed to open and close the outlet 36.

Further, the guide groove 340 is formed at an interior circumference of the inlet 35, and the guide plate 335 is disposed at a position corresponding to the guide groove 340.

A lower portion of the wax case 325 is inserted through a central portion of the guide plate 335, and the elastic member 330 is disposed at an exterior circumference of the wax case 325.

In this case, a lower portion of the elastic member 330 is supported by an upper surface of the guide plate 335, and an upper portion of the elastic member 330 elastically pushes the wax case 325 upward.

In various embodiments of the present invention, a coolant supplied to the inlet 35 is circulated to the EGR valve 150 through the guide plate 335, the housing space 37, and the branching path 38.

When a temperature of a coolant is low and the wax 320 is contracted, if the piston case 310 pulls up the piston shaft 305 by an elastic force of the elastic member 330 and a contraction force of the wax 320, the first valve 315 closes the outlet 36.

Therefore, since a coolant does not circulate to the oil cooler 160 and it is supplied only to the EGR valve, a coolant of a relatively low temperature is rapidly warmed up.

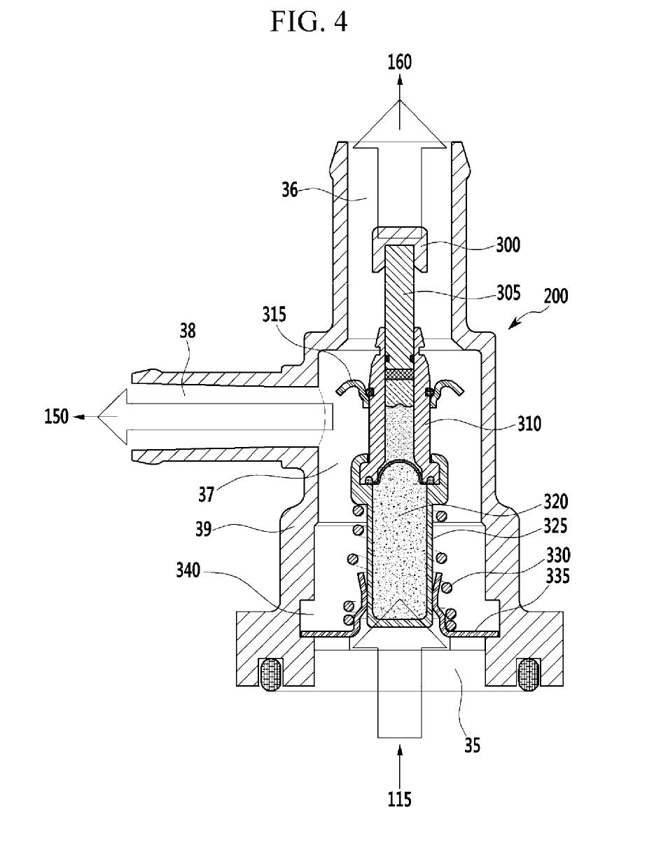

FIG. 4 is overall cross-sectional view showing operation states of a thermostat in a high temperature coolant state according to various embodiments of the present invention.

Referring to FIG. 4, a coolant supplied to the inlet 35 is circulated to the EGR valve 150 through the guide plate 335, the housing space 37, and the branching path 38.

When a temperature of a coolant is high, and if the piston case 310 pushes the piston shaft 305 while the wax 320 is expanded and compresses the elastic member 330, the first valve 315 opens the outlet 36.

Therefore, a coolant is supplied to the oil cooler 160 and the EGR valve 150, so that the oil is effectively cooled.

In various embodiments of the present invention, an edge of the guide plate 335 is inserted to the guide groove 340, and the guide plate 335 is disposed to move vertically through the guide groove 340.

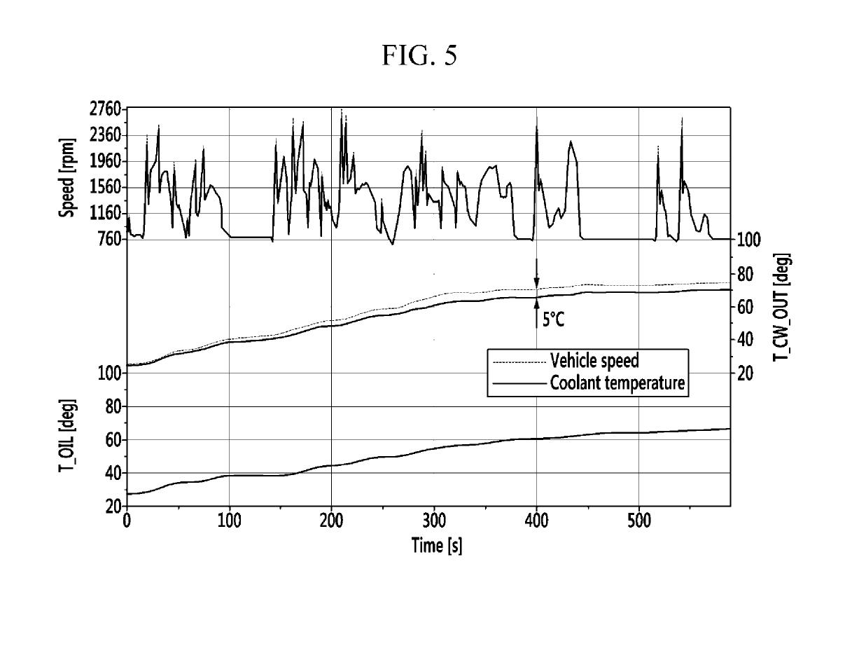

FIG. 5 is a graph showing effectiveness of using a thermostat according to various embodiments of the present invention, wherein the horizontal axis denotes time, and the vertical axis denotes an oil temperature, a coolant temperature, and an engine rotation speed (RPM) in an upward direction.

Based on 400 seconds, between the conventional coolant temperature and the coolant temperature according to the present invention in a coolant temperature line, a difference of about 5° C. is represented, and the coolant temperature according to the present invention is higher.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine cooling system having thermostat, comprising:
a cylinder head disposed on a cylinder block and forming a combustion chamber with the cylinder block, and configured to include an intake port and an exhaust port connected to the combustion chamber;
a coolant valve configured to receive a coolant that is passed through the cylinder head and the cylinder block and exhausted from each of a first side of the cylinder head and the cylinder block, and configured to distribute the coolant to cooling elements;
an oil cooler disposed to control temperature of an oil that circulates through the cylinder head or the cylinder block; and
a thermostat configured to receive a coolant exhausted from a second side of the cylinder block, and selectively transmit the coolant to the oil cooler.

2. The engine cooling system of claim 1, wherein the cooling elements comprise:
a radiator configured to disperse heat of the coolant to an outside;
an Exhaust Gas Recirculation (EGR) cooler disposed on an EGR line which is configured to recirculate an exhaust gas exhausted from the exhaust port to the intake port, and disposed to cool a recirculation exhaust gas; and
a heater disposed to heat internal air of a vehicle.

3. The engine cooling system of claim 1, further comprising:
an EGR line configured to recirculate an exhaust gas, which is discharged from the exhaust port to the intake port, to the intake port; and
an EGR valve disposed in the EGR line,
wherein the coolant having passed through a first side of the thermostat is passed through one side of the EGR valve and cools it.

4. The engine cooling system of claim 3, wherein
the thermostat is configured to continuously circulate the coolant supplied from the cylinder block to the EGR valve.

5. The engine cooling system of claim 3, wherein the thermostat comprises:
a thermostat housing having an inlet that is supplied with a coolant from the cylinder block at the first side, having an outlet that supplies the coolant to the oil cooler at a second side, having a housing space between the inlet and the outlet, and having a branching path that is branched from the housing space and connected to the EGR valve;
a piston shaft having a first end portion fixed to a fixing unit that is fixed at a central portion of the outlet;
a piston case in which a second end portion of the piston shaft is inserted;
a wax case engaged to the piston case, and filled with a wax according to a temperature therein; and
a first valve fixed to an outer part of the piston case and disposed to open and close the outlet according to a contraction and expansion state of the wax.

6. The engine cooling system of claim 5, wherein the thermostat further comprises:
a guide plate of which an end portion of the wax case is disposed to be inserted at a central portion, and an edge is disposed at a guide groove that is formed at an interior circumference of the inlet; and
an elastic member elastically supporting the wax case toward the fixing unit with respect to the guide plate so as to close the outlet by the first valve.

7. The engine cooling system of claim 2, wherein
the EGR cooler and the heater are sequentially disposed at a coolant line to supply the coolant having passed through the EGR cooler to the heater.

8. The engine cooling system of claim 7, wherein
the coolant valve is configured to separately control a coolant supplied to the EGR cooler and the radiator, and continuously receive the coolant from the cylinder head and selectively receive the coolant from the cylinder block.

9. The engine cooling system of claim 6, wherein
an edge of the guide plate is inserted to the guide groove, so as to move from the inlet to the outlet along a length direction of the guide groove.
